(19) United States
(12) Patent Application Publication
(10) Pub. No.: US 2007/0108913 A1
(43) Pub. Date: May 17, 2007

(54) Operating method for a high-pressure discharge lamp

(75) Inventors: Klaus Gunther, Berlin (DE); Thomas Hartmann, Berlin (DE); Gunther Hirschmann, Munchen (DE); Bernard Siessegger, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHAL, Munchen (DE)

(21) Appl. No.: 10/564,839

(22) PCT Filed: Jul. 19, 2004
(86) PCT No.: PCT/DE04/01562

§ 371 Date: Jan. 17, 2006

(30) Foreign Application Priority Data
Jul. 23, 2003 (DE) 103 33 740.7

(51) Int. Cl. H01J 13/46

(52) U.S. Cl. 315/56

(57) ABSTRACT

The invention relates to an operating method for a high-pressure discharge lamp which comprises a transparent discharge vessel (1), enclosing a substantially cylindrical discharge chamber (10), in which electrodes (2, 3) and an ionizable charge, for generating a light-emitting gas discharge, are arranged, whereby the aspect ratio is higher than 0.86. According to said invention, the high-pressure discharge lamp is operated by means of a substantially sinusoidal current at a preset frequency, lying in a frequency range above 30 kilohertz and free from acoustic resonances.

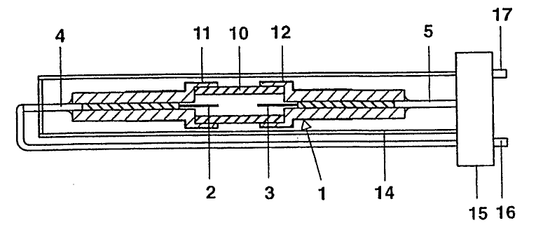

The invention relates to an operating method for a high-pressure discharge lamp according to the preamble of patent claim 1.

### I. PRIOR ART

The laid-open specification EP 0 708 579 A1 discloses an operating method for a high-pressure discharge lamp, in which the lamp is operated using a frequency-modulated alternating current.

According to the laid-open specification EP 0 386 990 A2, a metal-halide high-pressure discharge lamp is operated using a frequency-modulated alternating current, in order to induce acoustic resonances in a controlled manner for the purpose of straightening the discharge arc which is curved owing to convection.

The patent specification EP 0 626 799 B1 describes operation of a high-pressure discharge lamp using an alternating current, whose frequency is matched to a radial, acoustic resonance, for the purpose of straightening the discharge arc which is curved owing to convection.

It is also known to operate a high-pressure discharge lamp using a square-wave current of approximately 500 hertz.

Frequency modulation of the lamp current in accordance with the above-cited laid-open specifications requires considerable circuitry complexity. Operation of the high-pressure discharge lamp using an alternating current, whose frequency is matched to a radial, acoustic resonance, is likewise complex, since, owing to the production tolerances for each lamp, frequency matching using the operating device is required. Operation of the high-pressure discharge lamp using a square-wave current has the disadvantage that, at high lamp currents, such as are required, for example, for operating mercury-free metal-halide high-pressure discharge lamps, there are considerable power losses in the transistor switches and comparatively high complexity is required for radio interference suppression, owing to broadband interference signals which are caused by the lamp.

### II. SUMMARY OF THE INVENTION

The object of the invention is to provide a simplified operating method for a generic high-pressure discharge lamp which makes possible stable lamp operation without any interference owing to acoustic resonances in the discharge medium.

This object is achieved according to the invention by the features of patent claim 1. Particularly advantageous refinements of the invention are described in the dependent patent claims.

The operating method according to the invention is suitable for high-pressure discharge lamps, whose discharge vessel surrounds a discharge space having an essentially cylindrical geometry, and in which electrodes and an ionizable filling are arranged for the purpose of generating a light-emitting gas discharge, the aspect ratio, i.e. the quotient of the electrode spacing and the internal diameter of the discharge vessel, being preferably greater than 0.86 and particularly preferably even greater than 2. A discharge space having an essentially cylindrical geometry is understood to mean that the inner wall of the discharge vessel is cylindrical at least in the region of the gas discharge. According to the invention, such a high-pressure discharge lamp is operated using an essentially sinusoidal current at a frequency which is in a frequency range above 30 kilohertz and which is free from acoustic resonances.

It has been shown that a high-pressure discharge lamp having the above-described features, in contrast to high-pressure discharge lamps having spherical or elliptical discharge vessels, has relatively high frequency ranges above 30 kilohertz, which are free from acoustic resonances and can be used for stable operation of the high-pressure discharge lamp. The high-pressure discharge lamp is therefore operated, according to the invention, using an essentially sinusoidal alternating current at a predeterminable frequency in such a frequency window without frequency modulation of the lamp current. The operating method according to the invention makes it possible to considerably simplify the operating device. As compared with the operating methods described in the laid-open specifications EP 0 708 579 A1 and EP 0 386 990 A2, the part of the operating device which is required for frequency modulation is dispensed with. In comparison to the abovementioned operation of the high-pressure discharge lamp using a square-wave current, the operating method according to the invention allows for low complexity for radio interference suppression and fewer power losses at higher lamp currents, since the lamp does not generate any notable broadband interference signals in the case of a sinusoidal lamp current.

The high-pressure discharge lamp is preferably operated using a sinusoidal alternating current, whose frequency is in a frequency range between two adjacent acoustic resonances. Of particular preference is a frequency range between two adjacent fundamental frequencies of acoustic resonances, since, when operating at a frequency from a correspondingly low frequency range for the lamp current, the starting circuit and the means for radio interference suppression of the operating device may have a simple design.

The abovementioned, resonance-free frequency range is broad enough to carry out power regulation of the high-pressure discharge lamp by altering the frequency of the lamp current. The high-pressure discharge lamp is preferably operated immediately after starting the gas discharge at a higher power than the rated power by the high-pressure discharge lamp being subjected to a sinusoidal alternating current, whose frequency is lower than the frequency of the lamp alternating current during steady-state operation. During steady-state operation of the high-pressure discharge lamp, which is achieved when all of the components of the ionizable filling have reached their equilibrium vapor pressure, another, for example a higher, frequency is set for the lamp current than during the starting phase.

### III. DESCRIPTION OF THE PREFERRED EXEMPLARY EMBODIMENT

The invention will be explained in more detail below with reference to a preferred exemplary embodiment.

The figure shows a schematic illustration of a high-pressure discharge lamp, which is suitable for the operating method according to the invention and is used to describe, by way of example, the operating method according to the invention.

This lamp is a mercury-free high-pressure discharge lamp having a power consumption of 25 watts to 35 watts which is envisaged for use in a motor vehicle headlamp. The discharge vessel 1 of this lamp has a tubular, cylindrical central section 10, which is made of sapphire. The open ends of the section 10 are each closed by a ceramic closure piece 11 and 12, respectively, made of polycrystalline aluminum oxide. The internal diameter of the circular-cylindrical section 10 is 1.5 millimeters. Two electrodes 2, 3 are arranged on the longitudinal axis of the discharge vessel 1, with the result that their discharge-side ends protrude into the interior of the central, cylindrical section 10 and have a spacing of 4.2 millimeters. The ionizable filling which is enclosed in the discharge vessel 1 consists of xenon having a cold filling pressure of 5000 hectopascals and a total of 4 milligrams of the iodides of sodium, dysprosium, holmium, thulium and thallium. The electrodes 2 and 3 are each connected to an electrical connection 16 and 17, respectively, of the lamp base 15 via a power supply line 4 and 5, respectively. The discharge vessel 1 is surrounded by a light-transmissive outer bulb 14.

Using the electrode spacing, the internal diameter of the cylindrical section 10 and the speed of sound in the discharge medium, which is approximately 560 m/s, the acoustic resonant frequencies of the high-pressure discharge lamp can be calculated. The fundamental frequency of the longitudinal acoustic resonance is 70 kilohertz. The fundamental frequency of the azimuth acoustic resonance is 230 kilohertz, and the fundamental frequency of the radial acoustic resonance is 476 kilohertz. This means that the fundamental frequency of the abovementioned acoustic resonances in the discharge space would in each case be excited by an alternating current having a frequency which is half as great as that of the abovementioned resonances. Owing to the high aspect ratio of 2.8 and the low internal diameter, the acoustic resonances differ widely. Between the abovementioned acoustic resonances is in each case a resonance-free frequency range, in which stable lamp operation is possible without frequency modulation of the lamp alternating current. The high-pressure discharge lamp is operated using a sinusoidal alternating current, whose frequency is either in the frequency range from 50 kilohertz to 100 kilohertz or in the frequency range from 150 kilohertz to 200 kilohertz, for example using a sinusoidal alternating current of 75 kilohertz or 175 kilohertz. The first-mentioned frequency range is thus between the fundamental frequency of the longitudinal acoustic resonance, which is excited by an alternating current of 35 kilohertz, and the fundamental frequency of the azimuth acoustic resonance, which is excited by an alternating current of 115 kilohertz. The second-mentioned frequency range is between the fundamental frequency of the azimuth acoustic resonance, which is excited by an alternating current of 115 kilohertz, and the fundamental frequency of the radial acoustic resonance, which is excited by an alternating current of 238 kilohertz.

Further resonance-free frequency ranges, which make stable lamp operation possible, exist between the first harmonic of the abovementioned acoustic resonances, which are at frequencies of 140 kilohertz (first harmonic of the longitudinal acoustic resonance), 460 kilohertz (first harmonic of the azimuth acoustic resonance) and 952 kilohertz (first harmonic of the radical acoustic resonance) and are in each case excited by an alternating current having half the frequency.

The burning voltage of the high-pressure discharge lamp is approximately 30 volts to 50 volts, and the r.m.s. value of the sinusoidal lamp current is approximately 0.6 amperes. The color temperature of the light emitted by the lamp is approximately 4000 kelvin and the color rendering index is approximately 70.

The invention is not restricted to the exemplary embodiment explained in more detail above. In particular, the operating method according to the invention may also be applied to the high-pressure discharge lamp disclosed in laid-open specification DE 103 12 290. This lamp is a mercury-free halogen metal vapor high-pressure discharge lamp with an electrical power consumption of approximately 35 watts. This lamp is intended for use in motor vehicle headlamps. It has a discharge vessel 30 made from quartz glass with a volume of 24 mm³ which is sealed on two sides and in which an ionizable filling is enclosed in a gastight manner; the discharge vessel is surrounded by an outer bulb. In the region of the discharge space, the internal contour of the discharge vessel is cylindrical, while its external contour is ellipsoidal in form. The internal diameter of the discharge space is 2.6 mm, and its external diameter is 6.3 mm. The spacing between the two lamp electrodes is 4.2 mm. The ionizable filling enclosed in the discharge vessel consists of xenon having a cold filling pressure of 11 800 hPa, 0.25 mg of sodium iodide, 0.18 mg of scandium iodide, 0.03 mg of zinc iodide and 0.0024 mg of indium iodide.

1. An operating method for a high-pressure discharge lamp having a light-permeable discharge vessel (1), which surrounds a discharge space (10) having an essentially cylindrical geometry, in which electrodes (2, 3) and an ionizable filling are arranged for the purpose of generating a light-emitting gas discharge, characterized in that the high-pressure discharge lamp is operated using an essentially sinusoidal current at a frequency which is in a frequency range above 30 kilohertz and which is free from acoustic resonances.

2. The operating method as claimed in claim 1, characterized in that the frequency range is between two adjacent acoustic resonant frequencies.

3. The operating method as claimed in claim 2, characterized in that the frequency range is between two adjacent fundamental frequencies of acoustic resonances.

4. The operating method as claimed in claim 1, characterized in that the high-pressure discharge lamp is operated at a first, higher power immediately after starting the gas discharge and at a second, lower power once steady-state operation has been achieved, the frequency of the current through the lamp being set to a first value from the frequency range for the purpose of setting the first, higher power, and the frequency of the current through the lamp being set to another, second value from the frequency range for the purpose of setting the second, lower power.
